(19) United States
(12) Patent Application Publication
(10) Pub. No.: US 2025/0370780 A1
(43) Pub. Date: Dec. 4, 2025

(54) AUTOMATION SYSTEM AND METHOD USING VISION-LANGUAGE AGENT

(71) Applicant: Infofla Inc., Seoul (KR)

(72) Inventor: In Mook Choi, Seongnam-si (KR)

(21) Appl. No.: 19/210,396

(22) Filed: May 16, 2025

(30) Foreign Application Priority Data
May 28, 2024 (KR) 10-2024-0069427
Mar. 28, 2025 (KR) 10-2025-0040358
Mar. 31, 2025 (KR) 10-2025-0041140

(51) Int. Cl. G06F 9/455; G06F 11/07; G06F 11/3698

(52) U.S. Cl. CPC G06F 9/45512; G06F 11/079; G06F 11/3698

(57) ABSTRACT

Disclosed are an automation system and method using a vision-language agent (VLAgent) in which a screen recognition technology and a language model are combined. The system includes an input unit configured to receive a natural language-based task request from a user, a local VLM configured to recognize a task request and a current display screen to automatically generate a detailed step-by-step plan and script for performing the task, an automation main system configured to process the generated script, an RPA component configured to perform an action in an actual screen, and an object detection and text recognition module. Provided is an intelligent automation system that overcomes limitations of existing RPA, allows general users to configure task automation in natural language without experts, and may flexibly respond to UI changes.

### BACKGROUND OF THE DISCLOSURE

### Field of the Disclosure

The present disclosure relates to artificial intelligence (AI)-based task automation technology, and more particularly to a system and method for automatically performing various tasks according to a natural language request of a user using a vision-language agent (VLAgent) that combines screen recognition technology and a large language model.

### Description of the Related Art

Conventional RPA (Robotic Process Automation) technology has been used to automate repetitive and standardized tasks. However, existing RPA technology has the following limitations.

Since script writing by experts is essential, it is difficult for general users to directly utilize the technology, and task managers not having programming knowledge have limited ability to implement automation.

Since support in remote (RDP) environments is limited or impossible, usability in various task environments deteriorates, and application in cloud or virtualized environments is particularly difficult.

As the number of processes increases, complexity of maintenance exponentially increases, which leads to rapidly increasing management costs, and interdependence between processes makes modifications and updates difficult.

It is difficult to respond to new environments such as UI changes or system updates, so continuous script modifications are required, which undermines stability and reliability of automation.

Since the ability to handle exceptions is limited, it is difficult to appropriately respond when errors occur, and flexible processing of unstructured data or dynamic changes is impossible.

Due to these limitations, usability of RPA in an actual task environment is limited, and there is a problem of low cost efficiency due to the need for continuous intervention of an expert.

### SUMMARY OF THE DISCLOSURE

Challenges to be solved by the present disclosure are as follows.

The present disclosure provides an intuitive and user-friendly automation system that allows an ordinary user not having programming knowledge to instruct and execute a task in natural language without help of an expert.

The present disclosure provides an automation method that may flexibly respond to changes or updates in a user interface by utilizing screen recognition technology and AI and stably operates in various screen configurations and layouts.

The present disclosure provides a versatile automation system that may smoothly operate in various computing environments such as a remote desktop (RDP), a virtualization environment, and a cloud-based system in addition to a local PC environment.

The present disclosure provides an intelligent automation system that may automatically search for alternative routes and establish and execute appropriate response measures even when unexpected errors or exceptions occur through AI-based situational awareness and decision-making.

The present disclosure provides a system that may adapt to system updates or environmental changes without separate modification through self-learning and continuous performance improvement functions, thereby minimizing human and time resources required for maintenance.

In accordance with an embodiment of one aspect of the present disclosure, the above and other objects can be accomplished by the provision of an automation system using a vision-language agent (VLAgent) in which a screen recognition technology and a language model are combined, the automation system including an input unit configured to receive a natural language-based task request including a rule-based workflow designed with a set methodology and order from a user, a local vision-language model (VLM) including a screen recognizer (VIT) configured to capture and analyze a display screen to extract visual information, a language model (LLM) configured to understand user request content and analyze context, and a task plan and script generator configured to generate an automation execution plan and script for processing a workflow requested by the user based on information processed by the VIT and the LLM, a real-time object recognition RPA component configured to perform one or more of actions of coordinate-based click and text input on a screen according to an instruction of an automation main system (ITOMS) that processes a script generated by the local VLM and manages execution, and an AI model including an object detection and text recognizer configured to identify a UI element and text on the screen.

In another embodiment of the present disclosure, the VIT and the LLM of the local VLM may exchange information with each other and collaborate to perform integrated processing of visual information and text information.

In another embodiment of the present disclosure, the automation execution plan generated by the task plan and script generator may include two steps of task planning and action planning, the task planning may decompose a user request into a plurality of detailed tasks, and the action planning may convert each detailed task into one or more actual executable specific actions among a click action that designates a specific location on the screen as pixel-unit coordinates and a text input action that automatically inputs required text.

In another embodiment of the present disclosure, the system may further include an automation verification unit configured to perform verification in a test environment before execution of a generated task execution script, optimize the script based on a verification result, and then apply the script to an actual environment.

In another embodiment of the present disclosure, the real-time object recognition RPA component may verify a plan in a test environment, then execute the plan in a real environment, and perform a task by receiving continuous support from the AI model.

In another embodiment of the present disclosure, the AI model may further include a load prediction and fault discriminator, and the system may further include a server/web fault detector configured to automatically detect and analyze server and web faults and notify the ITOMS.

In another embodiment of the present disclosure, the AI recognition model may include input data of image-text pair data and output data of action data for an action type.

In accordance with another aspect of the present disclosure, there is provided a method performing an automated task by utilizing a natural language-based task request and screen data includes receiving a natural language-based task request from a user, capturing and analyzing a current display screen, automatically generating a task execution plan and script including two steps of task planning and action planning by inputting the task request and a screen analysis result to the VLM, processing the generated script in an ITOMS, verifying safety of the generated task plan in a test environment and checking executability, performing one or more of a click action and a text input action based on accurate coordinates defined in a script through an RPA component, and providing a task execution result to a user.

In another embodiment of the present disclosure, the task planning step may decompose a user request into a plurality of detailed tasks, and the action planning step may convert each detailed task into one or more actual executable specific actions among a click action that designates a specific location on a screen as pixel-unit accurate coordinates and a text input action that automatically inputs required text.

In another embodiment of the present disclosure, the method may further include supporting a task of the RPA component in AI models, wherein the supporting may include providing object detection and text recognition and performing load prediction and fault determination.

In accordance with a further aspect of the present disclosure, there is provided a non-transitory computer-readable recording medium storing a computer program for implementing a VLAgent system for performance, the computer program including instructions to execute steps of receiving a natural language-based task request from a user, capturing and analyzing a current display screen, automatically generating a task execution plan and script including two steps of task planning and action planning by inputting the task request and a screen analysis result to the VLM, processing the generated script, verifying safety of the generated task plan in a test environment and checking executability, performing one or more of a click action and a text input action based on accurate coordinates defined in a script in an actual environment, and providing a task execution result to a user.

In accordance with a further aspect of the present disclosure, there is provided a system based on a vision-language agent for fault detection and automatic recovery including a fault detector configured to detect a server or web fault and generate a fault notification, a local VLM configured to receive a fault notification and capture and analyze a screen, an ITOMS configured to receive and manage a recovery plan generated by the local VLM, a real-time object recognition RPA component configured to verify the recovery plan in a test environment and then execute a recovery task in an actual environment, and an AI model configured to support object detection, text recognition, load prediction, and fault determination.

In another embodiment of the present disclosure, an entire process from fault detection to recovery result reporting may be automated in the system, a screen capture and analysis request may be processed after receiving a fault notification, a recovery plan may be generated and delivered, execution may be performed in an actual environment after verification in a test environment, a task may be performed by receiving support for object detection and text recognition and support for load prediction and fault determination, and a final result may be reported to a user.

In another embodiment of the present disclosure, an entire process from fault detection to recovery result reporting may be automated in the system, a screen capture and analysis request may be processed after receiving a fault notification, a recovery plan may be generated and delivered, execution may be performed in an actual environment after verification in a test environment, a task may be performed by receiving support for object detection and text recognition and support for load prediction and fault determination, and a final result may be reported to a user.

In accordance with a further aspect of the present disclosure, there is provided a method of training and generating a local VLM includes collecting seed data and configuring a standard dataset, augmenting data in a self-instruct manner, expanding a training dataset by generating similar data based on the augmented data, combining a VIT and an LLM, fine-tuning the local VLM using the expanded training dataset, and verifying model performance based on a CoV.

In another embodiment of the present disclosure, the training dataset may include input data of image-text pair data and output data of action data for an action type.

In another embodiment of the present disclosure, the method may include a data analysis and augmentation step and a fine-tuning step, in the data analysis and augmentation step, a standard dataset may be formed from seed data, and 10 times more similar data may be generated through self-instruct data augmentation, and in the fine-tuning step, the local VLM may be fine-tuned by combining the VIT and the LLM and verified based on the CoV.

In another aspect of the present disclosure, a screen element recognition system using an AI recognition model may include an input unit configured to receive an input screen including a UI element, text, and an image, an AI recognition model including an object detection model and a text recognition AI model, and an output unit configured to transmit an object position, text content, and UI status information processed by the AI recognition model to an RPA component.

In another embodiment of the present disclosure, the AI recognition model may include input data of image-text pair data and output data of action data for an action type.

In another embodiment of the present disclosure, the AI recognition model may include an object detection model based on YOLOv8 and a text recognition model based on TrOCR, and the system may process the UI element, the text, and the image on the input screen through YOLOv8 and TrOCR models to recognize the object position, the text content, and the UI status, and utilize these for RPA execution.

In accordance with a further aspect of the present disclosure, there is provided a method of training and generating a local VLM including collecting seed data and configuring a standard dataset, augmenting data in a self-instruct manner, expanding a training dataset by generating similar data based on the augmented data, combining a VIT and an LLM, fine-tuning the local VLM using the expanded training dataset, and verifying model performance based on a CoV.

In another embodiment of the present disclosure, the training dataset includes input data of image-text pair data and output data of action data for an action type.

In another embodiment of the present disclosure, the method may include a data analysis and augmentation step and a fine-tuning step, in the data analysis and augmentation step, a standard dataset may be formed from seed data, and 10 times more similar data may be generated through self-instruct data augmentation, and in the fine-tuning step, the local VLM may be fine-tuned by combining the VIT and the LLM and verified based on the CoV.

To solve the task, the present disclosure utilizes a VLAgent that combines a screen recognition technology (Vision) and a language model. The system of the present disclosure may include the following components.

The present disclosure includes a unit configured to receive a natural language command of the user as text or voice and convert the command into a form that may be processed by the system as an input unit configured to receive a natural language-based task request from the user. In addition, the present disclosure is installed independently on an internal network of a company and has a closed structure that does not exchange data with the outside, and implements a security mechanism that prevents sensitive company data from leaking to the outside (local installation configuration with enhanced security).

The present disclosure includes a unit configured to capture a screen in real time and identify and analyze an UI element, text, and an image in a screen as a screen recognizer (VIT) configured to recognize and analyze a current display screen. In addition, the present disclosure implements a core engine that plans detailed steps required to perform a task by comprehensively processing captured screen information and a natural language request from the user as a local VLM that combines the VIT and the LLM. In this way, the present disclosure provides a processing mechanism based on CoAT (Chain of Action Thought) that decomposes complex tasks into logical steps and sequentially executes the steps.

The present disclosure includes a system that converts planned tasks into actual executable commands and manages an execution order as an ITOMS that processes task plans and scripts generated by a vision-language model. In addition, the present disclosure implements an execution unit that emulates and performs actual user actions such as mouse clicks, keyboard inputs, and drag-and-drops as an RPA component (RPACA) that performs actions on an actual screen. In addition, the present disclosure may provide an AI-based verification mechanism that verifies and corrects determination of the VLM in real time (AI-based reliability verification structure).

The present disclosure includes an AI unit that accurately identifies a screen element and determines a status thereof by utilizing deep learning-based computer vision technology as an AI model for an object detection and text recognizer and a load prediction and fault discriminator. In addition, it is possible to implement a data collection mechanism that automatically records a task execution process of the user and converts the process into training data, and a self-learning structure that continuously improves performance of the system based on collected data.

The present disclosure includes a verification system that safely verifies a planned task and transfers the task to an actual environment as a test unit for application to an actual environment after testing in a virtual environment. In addition, the present disclosure may implement an integrated management structure that automates the entire process from fault detection to recovery and a prediction-based preemptive fault response mechanism (integrated automated life cycle management).

The present disclosure provides a modular architecture that allows easy addition of new automation services. In addition, the present disclosure may implement a data-driven service expansion mechanism and an interface structure for flexible integration with existing systems.

The present disclosure includes a license management mechanism based on service usage and expansion. In addition, the present disclosure may implement a step-by-step expansion support structure based on customer growth and a license tracking system for continuous revenue generation.

The VLAgent of the present disclosure recognizes a current screen when the user requests a task in natural language and automatically plans and executes detailed steps and actions required to perform the task. In this process, a CoAT method is applied to sequentially process multi-step tasks, and AI-based verification and correction are performed at each step to ensure high reliability.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1A is a diagram of an overall configuration of a vision-language agent VLAgent system according to an embodiment of the present disclosure, and FIG. 1B is a block diagram illustrating the overall configuration of the vision-language agent VLAgent system of FIG. 1A;

FIG. 2A is a diagram illustrating a configuration and task principle of a local vision-language model (VLM) according to an embodiment of the present disclosure;

FIG. 2B is a flowchart of a task automation processing process including the local VLM according to an embodiment of the present disclosure;

FIGS. 3A and 3B are flowcharts illustrating an agent action step of a task plan according to an embodiment of the present disclosure;

FIG. 4 is a diagram illustrating an automated computing environment according to an embodiment of the present disclosure; and

FIG. 5 is a diagram illustrating a server/web fault detection and recovery process according to an embodiment of the present disclosure.

FIG. 6 is a flowchart illustrating an enterprise task automation learning and generation process using a Local VLM (200) according to an embodiment of the present disclosure.

FIG. 7 is a flowchart illustrating a learning dataset development and augmentation process according to an embodiment of the present disclosure.

FIG. 8 is a flowchart illustrating a real-time object recognition RPA (400) development process according to an embodiment of the present disclosure.

FIG. 9 is a flowchart of an AI-based integrated management system (ITOMS) (300) development process according to an embodiment of the present disclosure.

### DETAILED DESCRIPTION OF THE DISCLOSURE

Hereinafter, preferred embodiments of the present disclosure will be described in detail with reference to the attached drawings.

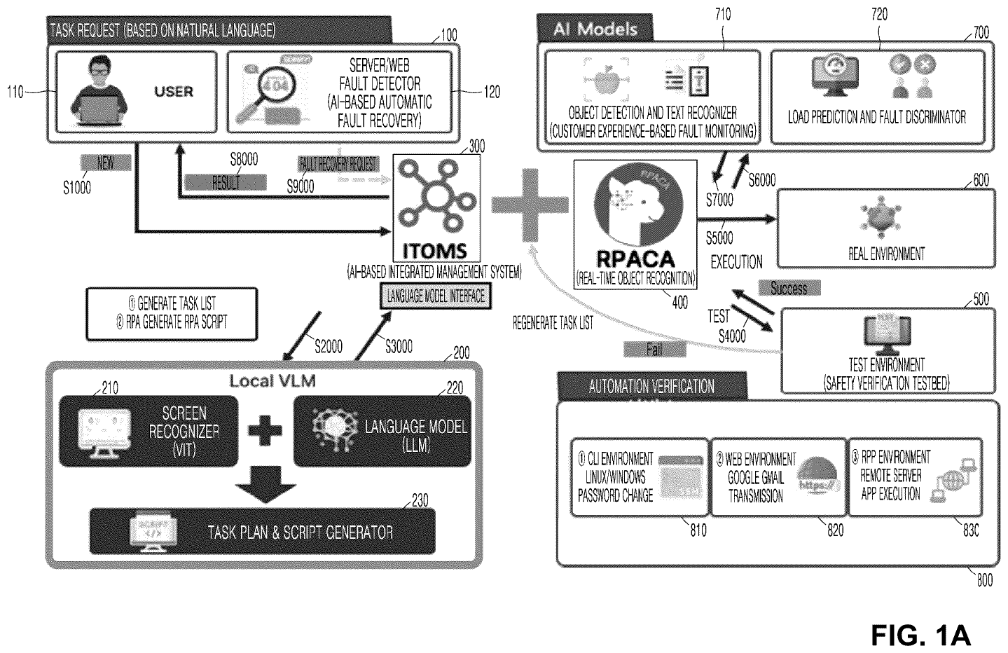

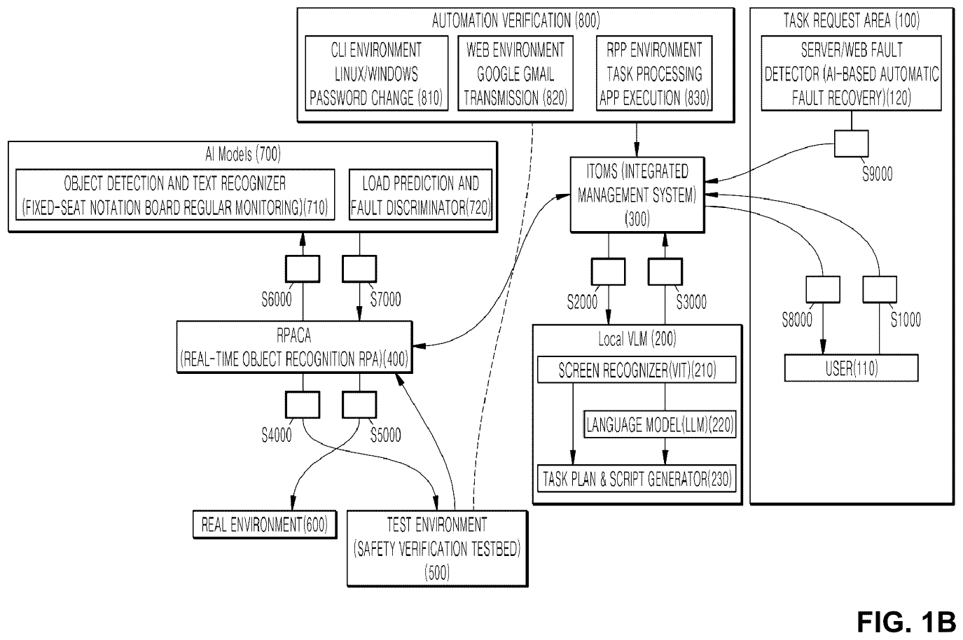

FIGS. 1A and 1B illustrate an overall configuration of a vision-language agent VLAgent system of the present disclosure. This system broadly includes a task request area 100, a local VLM 200, an AI-based integrated management system (ITOMS) 300, real-time object recognition RPA (RPACA) 400, environment areas 500 and 600, AI Models 700, and an automation verification area 800.

The task request area 100 includes a user input unit 110 and a server/web fault detector (AI-based automatic fault recovery) 120. The input unit 110 is a subject that requests a task in the form of natural language, transmits a command to a system as text or voice, and transmits a task request to the ITOMS 300 (S1000). The task in the form of natural language may include a rule-based workflow designed with a set methodology and order. The server/web fault detector 120 is responsible for automatically detecting a fault in the system and starting a recovery process based on AI, and transmits fault information to the ITOMS 300 when a fault occurs (S9000).

The ITOMS 300 is an AI-based integrated management system, which receives a user request and fault information, transmits the user request and fault information to the local VLM 200 (S2000), and functions as a central control system to execute a generated plan. In addition, the ITOMS 300 is responsible for reporting a final processing result to the input unit 110 S8000.

The local VLM 200 is a core engine of the system and operates by combining a screen recognizer (vision transformer VIT) 210 and a language model LLM 220. The screen recognizer 210 is responsible for capturing a current screen and identifying a UI element, and the language model 220 understands and processes a natural language request from the user. The natural language request may include a rule-based workflow designed with a set methodology and order. Through collaboration among these two units, a detailed execution plan is generated in a task plan and script generator 230 as a unit and transmitted to the ITOMS 300 (S3000). The task plan and script may include a rule-based workflow designed with a set methodology and order.

The RPACA 400 is a real-time object recognition RPA component that emulates actual user actions such as mouse click, keyboard input, and drag and drop according to instructions of the ITOMS 300 and performs tasks in the test environment 500 and the actual environment 600 (S4000 and S5000). The RPACA 400 functions as an execution unit that actually executes a planned task.

The environment area is divided into the test environment 500 and the actual environment 600. The test environment 500 is a space for safely verifying a task before applying the task to the actual environment, and does not affect the actual system in the event of an error. The actual environment 600 is an actual operating system environment where the task is ultimately performed.

The AI Models 700 include an object detection and text recognizer 710 as a unit and a load prediction and fault discriminator 720 as a unit. The object detection and text recognizer 710 is responsible for accurately identifying a UI element and text on a screen, and the load prediction and fault discriminator 720 as a unit performs a function of predicting system load and detecting a potential fault in advance. These two units support performance of a task of the RPACA 400 (S6000 and S7000) to increase accuracy and stability.

The automation verification area 800 provides automation verification functions in various environments such as Linux/Windows Password change in a CLI environment 810, Google Gmail transmission in a web environment 820, and task processing APP execution in an RPP environment 830. The CLI environment 810 is responsible for task verification in a command line interface, the web environment 820 is responsible for task verification based on a web browser, and the RPP environment 830 is responsible for task verification in an application for a task, and the environments operate in conjunction with the test environment 500.

Through organic interaction among these components, this system automates the entire process from a natural language request from the user to execution of an actual task and result reporting, and provides an integrated automation solution that enables automatic detection and recovery based on AI even in the event of a server/web fault.

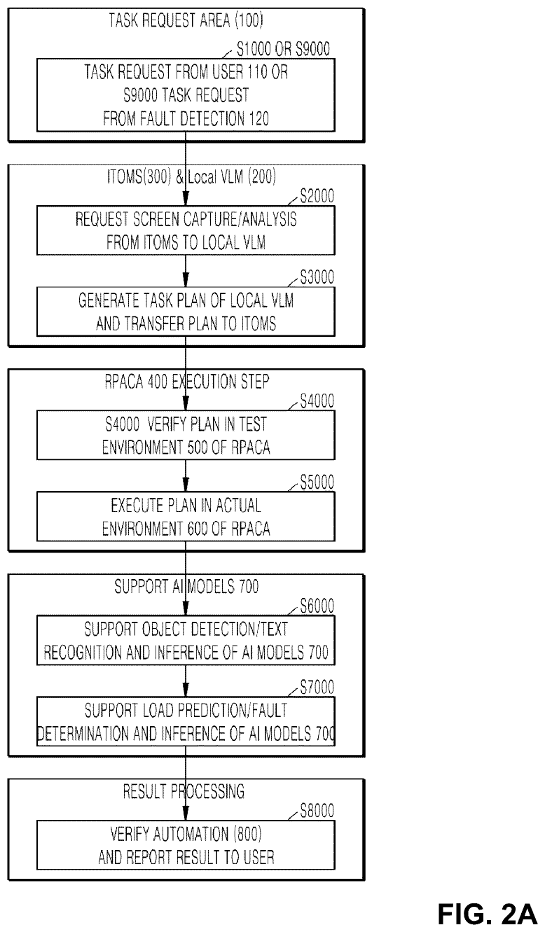

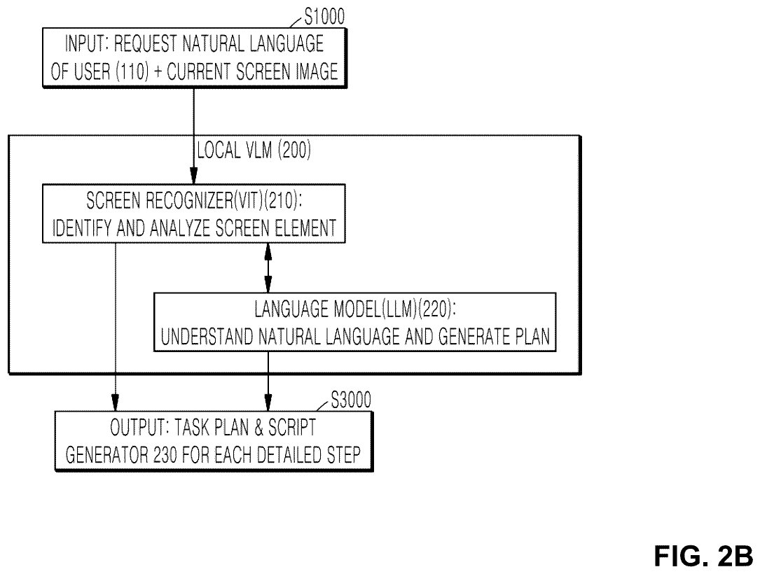

FIG. 2A is a flowchart illustrating an interaction between the ITOMS (AI-based integrated management system) 300 of FIG. 1B and the Local VLM 200. This process is a core process in the entire system illustrated in FIG. 1B and plays an important role in an initial stage of user request processing.

The Local VLM includes the screen recognizer (vision transformer VIT) 210, the language model LLM 220, and the task plan and script generator 230.

The screen recognizer (vision transformer VIT) 210 is a screen recognition processing unit based on the vision transformer, and captures and analyzes a screen of the user environment to extract visual information. The screen recognizer performs a function of identifying and classifying objects, text, UI elements, etc. on the screen. In FIG. 1B, the screen recognizer operates in conjunction with the object detection and text recognition unit 710 of the AI Models 700.

The language model LLM 220 is a natural language processing unit based on a large language model, which understands user request content and analyzes context. The language model performs a function of converting visual information extracted from the VIT into text and interpreting the text. The language model contributes to understanding task logic and generating processing steps.

The task plan and script generator 230 establishes an automation execution plan based on information processed by the VIT and the LLM. The generator generates scripts and commands required for task execution. The generator defines detailed steps of an automation task to be executed by the RPACA 400. The generator determines a priority and a flow of the task to be executed in the test environment 500 and the actual environment 600.

The interaction between the local VLM and the ITOMS illustrated in FIG. 2A proceeds in the following order. The ITOMS transmits a task request received from the input unit 110 or the server/web fault detector (AI-based automatic fault recovery) 120 to the local VLM (S2000). This occurs after the request (S1000) from the input unit 110 to the ITOMS 300 in the flow of FIG. 1B. In addition, this may occur after notification (S9000) from the server/web fault detector (AI-based automatic fault recovery) 120 to the ITOMS.

The following processing is sequentially performed in the local VLM. The screen recognizer VIT 210 captures and analyzes a current screen. The language model LLM 220 links and processes a user request and screen information. The VIT and the LLM exchange information and collaborate with each other. Based on output of the two units, the task plan and script generator 230 as a unit establishes an automation plan.

The generated task plan and script are transmitted back to the ITOMS (S3000). This information becomes a basis of data transmitted by the ITOMS to the RPACA 400 in FIG. 1B. The RPACA then executes this plan in the test environment 500 (S4000) and the actual environment 600 (S5000).

The interaction between the ITOMS and the local VLM depicted in FIG. 2A corresponds to an initial stage of the overall workflow depicted in FIG. 1.

In the task request area 100, the input unit 110 or the server/web fault detector (AI-based automatic fault recovery) 120 requests a task from the ITOMS (S1000 and S9000). The ITOMS transmits this request to the local VLM (S2000).

The local VLM processes the request, generates a task plan, and returns the task plan to the ITOMS (S3000). The ITOMS transmits this plan to the RPACA, and the RPACA performs a task with the support of the AI Models 700 (S6000 and S7000). The RPACA first verifies the plan in the test environment 500 (S4000), and then executes this plan in the real environment 600 (S5000). A result is delivered to the ITOMS after the automation verification 800 and finally reported to the user (S8000).

The server/web fault detector (AI-based automatic fault recovery) 120 continuously monitors the system, and when a fault occurs in the server or web application, the server/web fault detector immediately notifies the ITOMS (S9000). This notification is processed in the same way as the user request (S1000), and a fault situation is analyzed through the local VLM and an appropriate recovery plan is established. The fault recovery plan undergoes the same verification and execution process as that of a general task, but is processed quickly with a high priority.

An efficient information analysis function is provided through parallel processing of the VIT and the LLM. An integrated processing method of visual information and text information is implemented. Risk factors are identified and response measures are prepared in a planning stage before execution. A precise plan is established to execute a high-quality automated task.

The local VLM acts as a “brain” of the entire system and is a key element in determining quality of an automated task in a subsequent stage. Efficient interaction with the ITOMS directly affects performance and reliability of the entire system.

As illustrated in FIG. 2B, the local VLM 200 receives and processes a user natural language request 110 and a current screen image as input (S1000). Inside the local VLM, the screen recognizer VIT 210 that understands the visual information of the screen and the language model LLM 220 having natural language processing capability interact with each other. The screen recognizer VIT 210 is responsible for identifying UI elements such as buttons, text fields, and icons on the current screen and locating a position, and the language model LLM 220 analyzes the natural language request from the user to determine the intent and infers a necessary task step. These two units continuously exchange information and complementarily operate, transmitting a screen recognition result to the language model to enhance context, and feeding back an analysis result of the language model to screen recognition so that an important UI element may be focused on. Based on a combined analysis result thereof, the task plan and script generator 230 as a unit generates a detailed step-by-step task plan and execution script for performing the user request (S3000) and transmits the generated task plan and execution script to the ITOMS 300. In this process, a Chain of Action Thought (CoAT) method is applied so that complex multi-step tasks are systematically planned according to a logical sequence.

As described above, the local VLM 200 includes the screen recognizer VIT 210, the language model LLM 220, and the task plan and script generator 230.

The screen recognizer VIT 210 is a screen processing unit including a deep learning model based on a vision transformer, and includes a real-time screen capture and image preprocessing module, a UI element identification and location tracking module, a text OCR and image segmentation module, and an object recognition and relationship analysis module. This processing unit identifies locations and statuses of all UI components (buttons, text fields, drop-downs, etc.) on the screen, and tracks dynamically changing UI elements in real time. In addition, this processing unit performs a function of extracting multimodal information such as text, images, and icons, and analyzing a hierarchical structure and an interrelationship between screen elements.

The language model LLM 220 is a large-scale language model that operates in a local environment, and includes a natural language understanding and context recognition module, a task decomposition and planning module, a multi-stage inference and decision-making module, and an error handling and recovery strategy generation module. This language model converts the natural language request from the user into a structured task instruction, and integrates visual information received from the screen recognition processing unit with text context. In addition, this language model performs a function of decomposing a complex task into logical steps and generating an alternative path for an exceptional situation.

The task plan and script generator 230 is a processing unit that integrates results of the VIT and the LLM to generate an executable plan, and includes a task order optimization module, a script generation and verification module, a resource allocation and scheduling module, and an execution monitoring and feedback module. This processing unit establishes a step-by-step plan in the Chain of Action Thought (CoAT) manner, and analyzes a precedence and dependency of each task step. In addition, this processing unit generates an executable automation script and performs a function of monitoring task progress in real time.

A data synchronization and sharing mechanism, a parallel processing and optimization engine, a real-time feedback loop, and a cache and memory management system are provided as an integrated processing system for efficient collaboration among three units. This mechanism performs real-time data exchange and synchronization between processing units, optimizes task processing speed, efficiently manages system resources, and verifies accuracy of a processing result.

The entire task process of the local VLM proceeds in order of an initialization step, an analysis step, a planning step, and a verification and delivery step.

In the initialization step, the local VLM receives a task request from the ITOMS 300 (S2000), captures a current screen state, and performs an initial analysis. Thereafter, the local VLM allocates system resources and puts each processing unit into a ready state.

In the analysis step, the screen recognizer VIT 210 starts UI analysis, and at the same time, the language model processing unit 220 parses request content. The two processing units continuously exchange intermediate results and perform integrated analysis.

In the planning step, the task plan and script generator 230 establishes a CoAT-based detailed execution plan based on the integrated analysis result. In this process, a task is performed to generate and optimize an execution script.

In the verification and delivery step, executability of the generated plan is verified and resource usage and execution time are predicted. Finally, the verified plan is transmitted to the ITOMS (S3000) to proceed to an actual execution step.

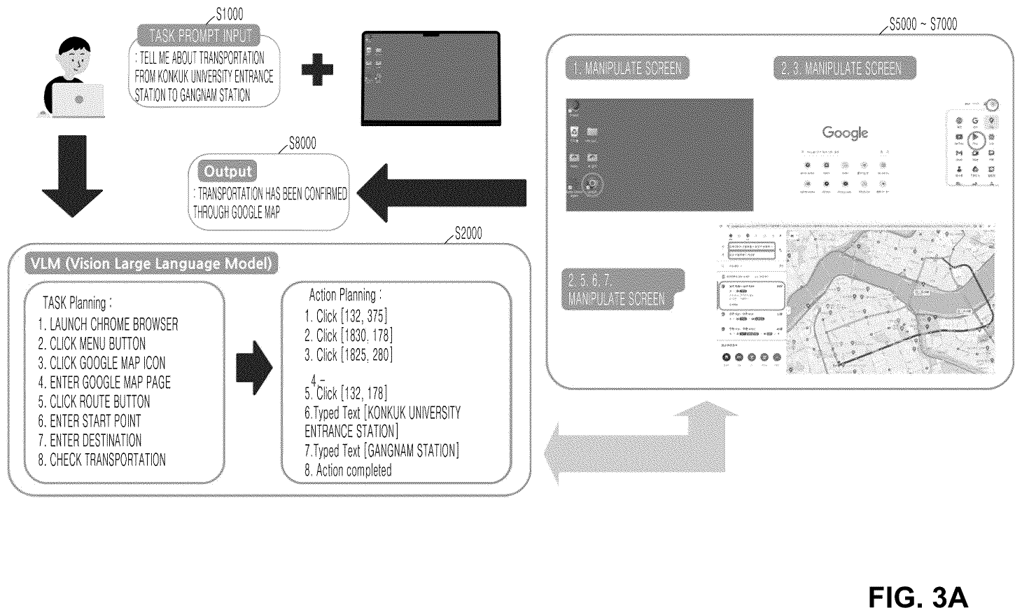

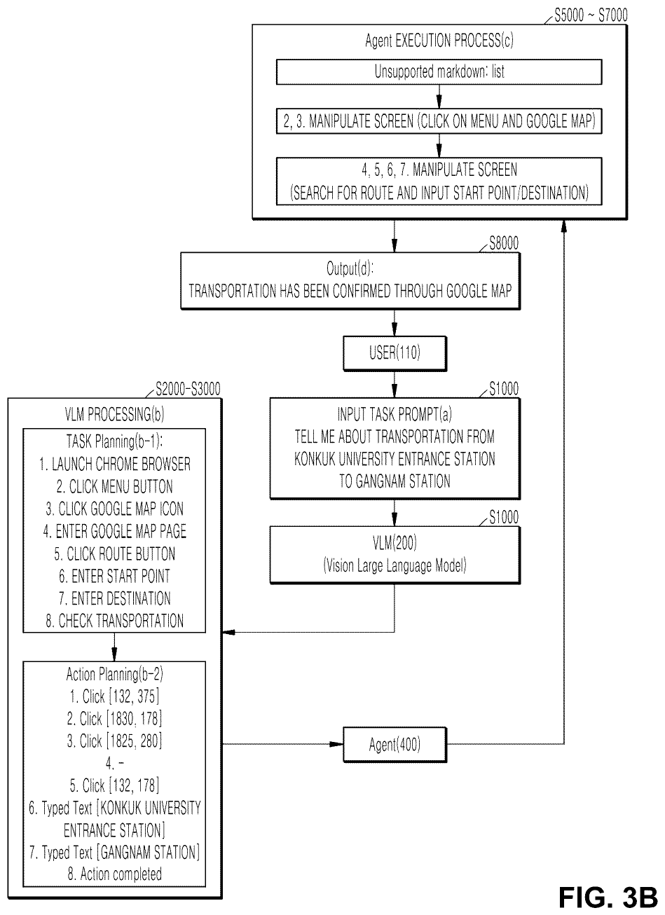

FIG. 3A and FIG. 3B are flowcharts illustrating an agent action step of the task plan according to an embodiment of the present disclosure. This flowchart shows the entire process in which the task request from the user is processed through the VLM and executed by an agent.

a) Task Request from User

The input unit 110 inputs a task prompt in natural language, for example, making a request such as “Tell me about transportation from Konkuk University Entrance Station to Gangnam Station.” In this instance, a user screen is captured and transferred to the VLM 200.

### b) Process of VLM 200

The VLM processes the user request in two steps: Task Planning: The user request is decomposed into detailed tasks, which includes steps of \textcircled{1} launching Chrome browser, \textcircled{2} clicking the menu button, \textcircled{3} clicking the Google Map icon, \textcircled{4} entering the Google Map page, \textcircled{5} clicking the route button, \textcircled{6} entering the start point, \textcircled{7} entering the destination, \textcircled{8} checking transportation, etc.

Action Planning: Each task step is converted into a specific action that may actually be executed, which includes \textcircled{1} Click [132, 375]—Click on the Chrome icon location, \textcircled{2} Click [1830, 178]—Click on the menu button location, \textcircled{3} Click [1825, 280]—Click on the Google Map icon location, \textcircled{4} (wait for page to load), \textcircled{5} Click [132, 178]—Click on the route button location, \textcircled{6} Typed Text [Konkuk University Entrance Station]—Enter start point text, \textcircled{7} Typed Text [Gangnam Station]—Enter destination text, \textcircled{8} Action Completed—Confirming task completion, etc.

### c) Execute Agent 400

The agent manipulates the actual screen according to the action plan generated in the VLM. The screen manipulation is performed in the following steps: launch Chrome browser (click the icon at the bottom left of the screen), access menu and Google Maps (click the menu at the top right of the screen and select Google Maps), search for route and enter information (click the route button, enter start point/destination), check transportation information displayed on the screen, etc.

### d) Output Result

After the task is completed, the agent reports the user a result, such as “Transportation has been confirmed through Google Map.” (S8000).

The VLM agent has the following technical features.

The VLM agent is a distributed processing structure that provides an efficient information analysis function through parallel processing of the screen recognizer VIT 210 and the LLM 220, and each unit operates independently but is organically linked.

As a multimodal processing method, an integrated processing method of visual information and text information is implemented, and a flexible structure capable of processing various types of input is provided.

With a step-by-step verification system, risk factors are identified in a pre-execution planning step, safety is ensured through verification in the test environment 500, and sufficient verification is performed before application to the actual environment 600.

By realizing intelligent automation, task accuracy is improved through continuous support of the AI models 700, and quality management is performed through the automation verification 800.

In order to enable precise coordinate-based task, a specific location on the screen is clicked by being designated as precise coordinates in units of pixels. For example, an exact location is designated in the form of Click [132, 375], Click [1830, 178], etc.

The VLM agent automatically enters required text into an input field. For example, text input automation is realized to enable text input in the form of Typed Text [Konkuk University Entrance Station], Typed Text [Gangnam Station], etc.

The local VLM functions as the “brain” of the entire system and is a key element that determines quality of automated task in a subsequent step. Efficient interaction with the ITOMS 300 directly affects performance and reliability of the entire system. In particular, automation of the entire process from user request to result report is realized, and safety is ensured through double verification of the test environment and the actual environment. Accuracy and efficiency of the task are improved through continuous support of the AI models, and reliability of the result is ensured through automation verification. In addition, the user does not need to understand the complex task process, but only needs to make a request in natural language, and the task may be completed without user intervention through complete automation of a screen-based task.

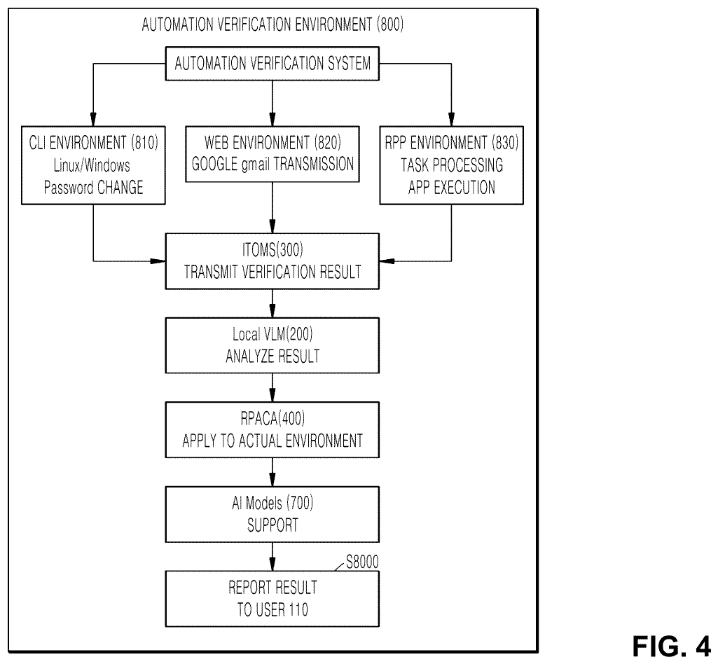

FIG. 4 illustrates an automation verification environment 800 of the present disclosure, and supports various types of automation verification. The automation verification system broadly provides three main verification environments, namely, Linux/Windows Password change in a CLI environment 810, Google Gmail transmission in a web environment 820, and task processing app execution in an RPP environment 830.

This automation verification environment plays an important role in the overall system structure illustrated in FIG. 1B. A verification result is transmitted to the ITOMS 300, analyzed in the local VLM 200, and then applied to the actual environment through the RPACA 400. In this process, accuracy and efficiency of the task are improved with the support of the AI Models 700, and the results are finally reported to the input unit 110.

In the CLI environment 810, password change tasks of Linux and Windows servers are automated and verified. This is an important scenario that tests automation capability of system management tasks through a command line interface, and is used for automation of server management and security-related tasks.

In the web environment 820, an email sending task through a web application such as Google Gmail is automated and verified. This is a scenario that tests automation capability of web browser-based tasks, and is used for automation of various web service usage.

In the RPP environment 830, execution and task of task processing applications are automated and verified. This is a scenario that tests automation capability of applications for internal company tasks, and is used for automation of repetitive office tasks.

Through these various verification scenarios, reliability and accuracy of the automation script may be verified, and only automation scripts that have been sufficiently verified in the test environment 500 are applied to the actual environment 600, thereby ensuring stability and reliability of the system. In addition, this verification process is performed more accurately and efficiently with the support of the function of the object detection and text recognizer 710 and the function of the load prediction and fault discriminator 720 of the AI models 700 as illustrated in FIG. 1B.

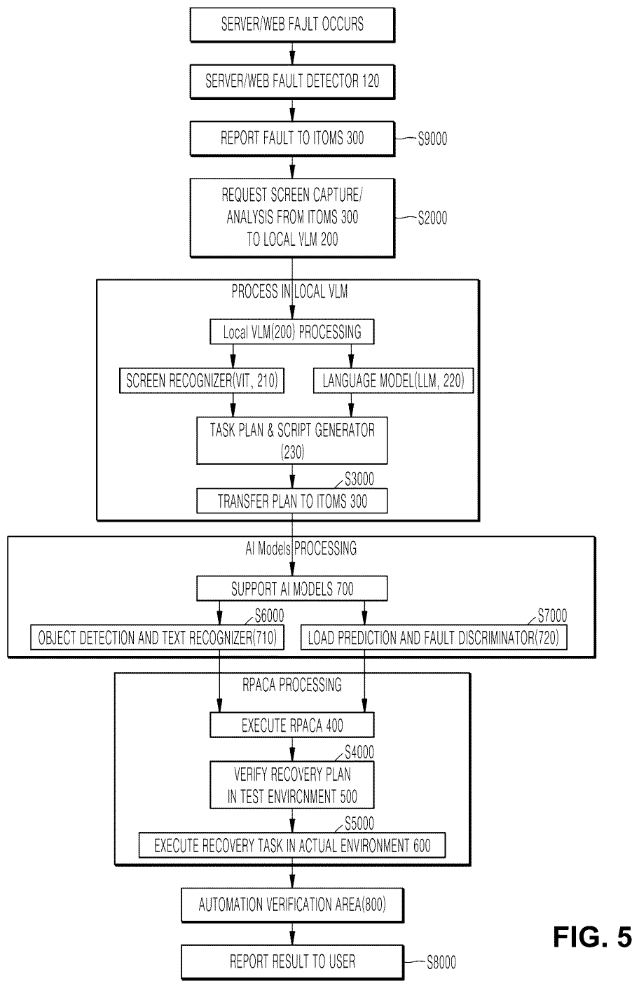

FIG. 5 illustrates a server/web fault detection and recovery process in detail. This process broadly includes steps of fault detection, analysis, recovery plan establishment, verification, execution, and result reporting.

First, when a server/web fault occurs, the server/web fault detector (AI-based automatic fault recovery) 120 as a unit is automatically activated to detect the fault and send a fault notification to the ITOMS 300 (S9000). This is a self-diagnosis function of the system, which enables recognition of a fault situation and start of a recovery process without direct intervention of the input unit 110.

The ITOMS receiving the fault notification sends a screen capture/analysis request to the local VLM 200 (S2000). In this instance, a screen where the fault has occurred is captured and transmitted to the VLM, and the VLM analyzes the screen to accurately identify the fault situation.

The local VLM analyzes the fault situation from various angles through the screen recognizer VIT 210 and the language model LLM 220. The screen recognition unit identifies error messages, abnormal UI elements, system status indications, etc. from the captured screen, and the language model performs a comprehensive analysis by understanding fault context along with this visual information. In this process, the two units work complementarily to accurately determine the cause and type of the fault.

When the analysis is completed, the VLM generates a recovery script through the task plan and script generator 230 and transmits the recovery script to the ITOMS (S3000). This script includes details such as an optimal recovery method according to the fault type, a required command sequence, and an expected system response.

The RPACA 400 receiving the recovery plan from the ITOMS first verifies the recovery plan in the test environment 500 (S4000). This is an important step to ensure safety before application to the actual environment, and verifies whether the recovery task does not cause unintended side effects.

When verification is completed in the test environment, the RPACA executes the recovery task in the actual environment 600 (S5000). In this process, various automated actions such as clicking based on precise coordinates, entering text, and executing commands are performed, and the system response is monitored at each step to track the recovery progress.

The support of the AI models 700 is provided throughout the recovery task. The object detection and text recognizer 710 accurately identifies screen elements and extracts text information to support the accurate task of the RPACA (S6000). In addition, the load prediction and fault discriminator 720 monitors the system load status and predicts and prevents secondary faults that may occur during the recovery process (S7000).

When all recovery tasks are completed, the final results are reported to the user (S8000). This report includes information such as the detected fault type, the performed recovery task, the current system status, and whether additional measures are required, so that the user may clearly understand the overall situation.

This entire process is fully automated, so that the fault situation may be quickly detected and recovered without human intervention, and safety and reliability are ensured through a double verification structure of the test environment and the actual environment. In addition, with the continuous support of the AI model, high-accuracy recovery tasks may be performed even in complex fault situations.

The present disclosure may be utilized in various fields. For example, the present disclosure may be utilized in IT service automation, office task automation, support for the visually impaired, entertainment, education, manufacturing, medical, customer service, etc. In particular, when a visually impaired person shops online, the VLAgent may recognize a screen and automate and support a purchase process.

Another feature of the present disclosure is that the present disclosure supports both cloud and local installation. Depending on the internal security policy of the company, the present disclosure may be locally installed in a closed network environment or used as a cloud service. In addition, since a person in charge may directly create a task of the person as training data, dependency on experts may be greatly reduced.

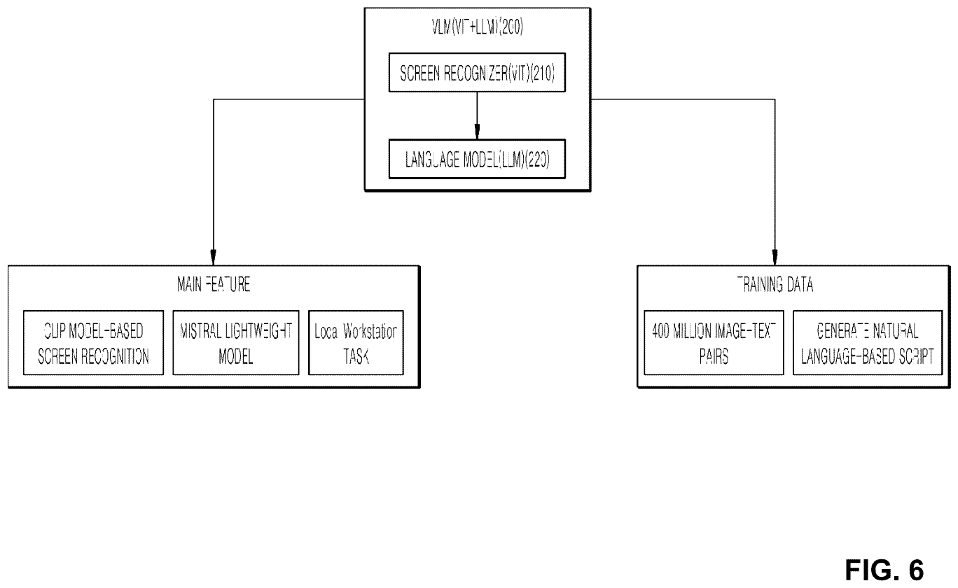

FIG. 6 illustrates a process of automated learning and generation of company tasks using the local VLM 200 of the present disclosure. Using the VLM (VIT+LLM, vision language model) 200, errors due to screen changes difficult to deal with using the existing LLM method may be prevented and more accurate command execution is possible. A process in which the local VLM 200, which plays a key role in the overall system configuration illustrated in FIG. 1B, processes the task request (S2000) received from the task request area 100 through the ITOMS 300, generates a task plan and script, and transmits the task plan and script to the ITOMS 300 (S3000) is illustrated in detail.

The screen recognizer VIT 210 uses a CLIP (Contrastive Language Image Pretraining model), in which a vision transformer is known to have high precision technology performance, and the LLM 220 uses a Mistral lightweight model, which is open source and has excellent Korean language performance. A task is performed on a local workstation for security. As described in FIG. 2B, this is based on a structure in which the screen recognizer VIT 210 and the language model LLM 220 interact to generate a final plan in the task plan and script generator 230.

The screen recognizer VIT 210 may be trained using, for example, data of a total of 400 million image-text pairs, and thus may flexibly perform classification and recognition tasks on new data and tasks never seen before. In addition, the language model LLM 220 is trained so that, when a task required by the input unit 110 is input in natural language, a task script required the corresponding task may be for automatically generated. In a task automation processing process illustrated in FIG. 2A, the local VLM 200 receives a user request and a screen image as input and systematically plans a complex multi-step task in a logical order by applying a (Chain of Action Thought) CoAT method.

The interaction between the ITOMS and the local VLM and the agent action steps described in FIGS. 3A and 3B are further specified in FIG. 6, which shows how a natural language request from the input unit 110 is converted into an executable task plan. In this process, a real-time object recognition function of the RPACA 400 illustrated in FIG. 4 is linked, which leads to a process in which the generated plan is verified and executed in the test environment 500 and the actual environment 600 (FIG. 5). This integrated approach greatly improves accuracy and reliability of company task automation.

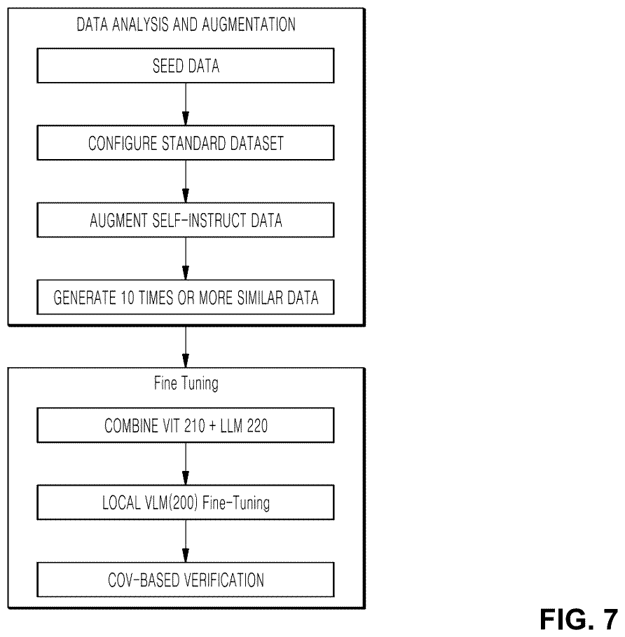

FIG. 7 illustrates a process of developing and augmenting a training dataset of the present disclosure. In order to train the VLM 200, large-scale training data is ensured through the self-instruct technique, and a hallucination phenomenon is verified to minimize errors. In the overall system configuration illustrated in FIG. 1B, the performance of the VLM 200 is largely dependent on the quality of the training data, and thus the present disclosure ensures this through a systematic data development and augmentation process. In a data analysis and augmentation step, a standard dataset in the form of episodes in which screen images and task texts are combined is constructed based on 100, 150, 200, or more than 200 pieces of seed data. In another embodiment of the present disclosure, a standard dataset may be constructed based on more seed data. In this process, the self-instruct data augmentation technique is utilized to perform human dataset generation, and the FewShot Learning methodology is applied to generate, for example, 10 times or more similar data, thereby ensuring diversity and scale of training data.

In order to make the most of the structural characteristics of the VLM 200 described in FIG. 2A and FIG. 2B, the combination of the VIT 210 and the LLM 220 is optimized in a fine-tuning step. In particular, considering connectivity with the ITOMS 300 depicted in FIG. 3A and FIG. 3B, domain knowledge fine-tuning learning is performed through the local VLM 200 with enhanced security, thereby preventing external leakage of company information. In addition, in order to ensure execution accuracy in the RPACA 400 and the test/actual environments 500 and 600 described in FIG. 4 and FIG. 5, a CoV (Chain of Verification)-based verification system is introduced to thoroughly examine hallucination, thereby ensuring accuracy and reliability of the generated script. This comprehensive training dataset development and augmentation process provides a foundation for the automation system based on the VLM 200 of the present disclosure to flexibly respond to various task environments and requirements.

A reason why CoV-based verification improves fine-tuning performance is as follows. In terms of preventing hallucination, the LLM may sometimes exhibit a hallucination phenomenon of generating information that does not actually exist, which is a factor that greatly reduces reliability of the automated system. CoV systematically detects and filters out hallucinations by verifying the generated results step by step. By using only verified data for fine-tuning, reliability of the model is greatly improved, and the value is further increased when used for important decision-making in a company environment.

The step-by-step verification system broadly includes three steps. In step 1, logical consistency of the generated response is verified to ensure that there are no internal contradictions. In step 2, consistency with actual screen information is verified to ensure consistency between the visual elements recognized by the VIT and the text generated by the LLM. In step 3, executability of the generated script is verified to ensure that tasks may be performed without error in the actual environment. Only data that has passed verification at each step is used for learning, which improves the overall quality of fine-tuning, and in particular, stability is greatly enhanced in complex multi-step task automation.

In terms of ensuring self-consistency, CoV includes a process of thoroughly checking whether results generated by the model are consistent with previously learned knowledge. Stability of the model is improved by fine-tuning using data whose consistency has been verified, and it is significantly important to ensure consistency between visual information and text information, especially in a multimodal environment where the VIT and the LLM are combined. This increases adaptability to screen changes and enables exhibition of consistent performance in various interface environments.

In terms of ensuring executability, it is essential to strictly verify whether the generated script is actually executable through CoV. Practicality is improved by using only executable scripts as training data, and a virtuous cycle is established in which the execution results in the test environment are used as feedback to continuously improve the model. This is closely linked to the double verification structure of the test environment 500 and the actual environment 600 described in FIGS. 4 and 5, and plays a key role in implementing a safe and reliable automation system.

In terms of domain-specific verification, there is an advantage in that specialized knowledge for a specific task domain may be systematically reflected in the CoV system. Domain-specific rules and constraints are included in a verification step to increase specificity of fine-tuning, and whether task regulations are complied with is thoroughly checked to greatly improve practical applicability. This is especially important in industries such as finance, medicine, and manufacturing where special regulations and processes are present, and is utilized as a method to effectively inject domain knowledge into the model.

Through this CoV-based verification system, high-quality training data may be systematically ensured during the fine-tuning process, and as a result, performance and reliability of the local VLM are greatly improved. Especially, when used for important decision-making and automation tasks in a company environment, this system serves as a basis for minimizing a possibility of errors and providing stable services.

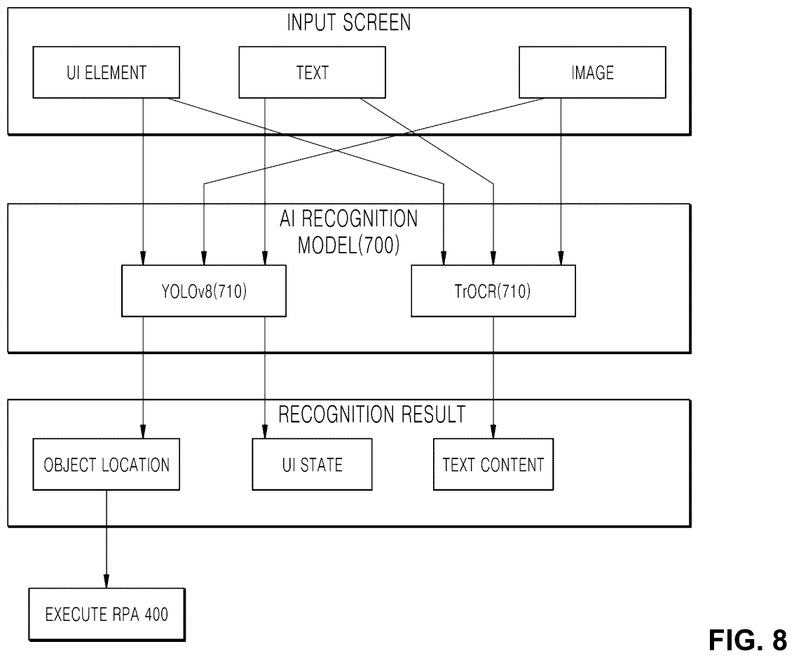

FIG. 8 illustrates a development process of the real-time object recognition RPA 400 of the present disclosure. Unlike existing RPAs, the image AI recognition-based RPA 400 that overcomes the limitations of recognition is developed, and a high-speed recognition model is applied to ensure responsiveness of the input unit 110. In the overall system configuration illustrated in FIG. 1B, the RPACA 400 is a key component that executes the script received from the ITOMS 300 and performs tasks in the test environment 500 and the actual environment 600.

The RPA object recognition capability through AI detection is expanded for all images such as icons, menus, and input windows appearing on the screen beyond a simple task method of existing RPA products based on XPath. Through OCR recognition of text images, a recognition range is expanded to include not only text-based recognition but also unlearned image objects. This is linked to a screen recognition function of the VLM 200 described in FIGS. 2A and 2B, and provides a basis for flexibly responding to changes in the user interface.

Main components of the real-time object recognition RPA 400 include YOLOv8 (Object Detection Model) 710 that detects and classifies objects on the screen in real time, and TrOCR (Transformer-based Optical Character Recognition) 710 that accurately recognizes text images and converts the text images into text. These AI models operate according to instructions of the ITOMS 300 illustrated in FIGS. 3A and 3B, and perform actions such as clicking and text input based on accurate coordinates for performing tasks in the test environment 500 and the actual environment 600 described in FIG. 5.

Through AI recognition of objects and text, it is possible to effectively deal with unexpected situations such as changes in the UI of the web/app or modal dialogs, and to ensure high-speed responsiveness through an AI model algorithm and recognition data tuning. In addition, it is possible to operate on various operating systems such as Windows, Mac, and Linux through OS-independent AI recognition technology. This further enhances the real-time object recognition and action execution capabilities of the RPACA 400 described in FIG. 4, thereby ensuring stable automation execution even in complex task environments.

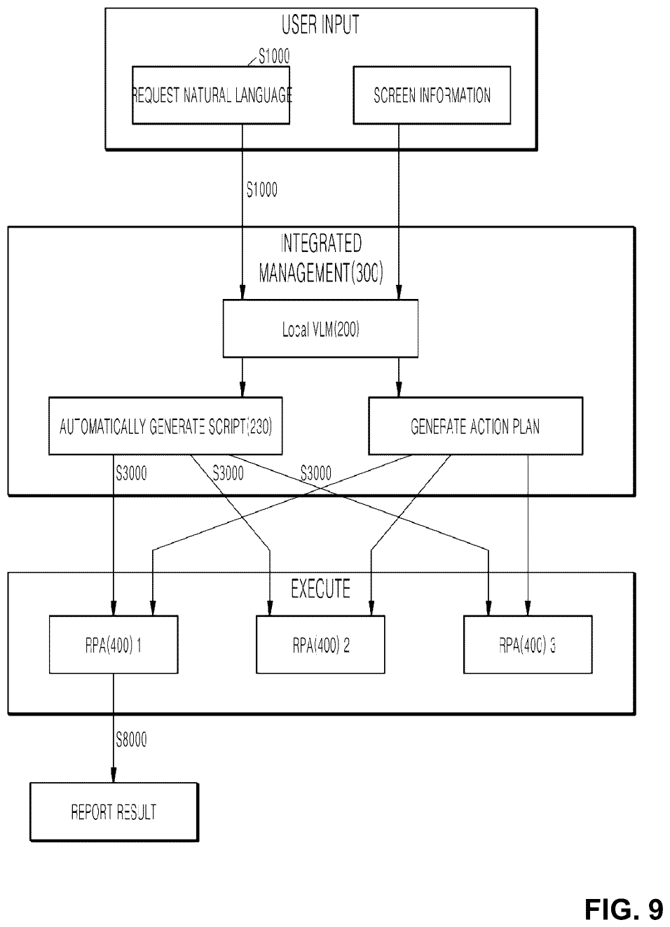

FIG. 9 illustrates a development process of the AI-based integrated management system ITOMS 300 of the present disclosure. In order to expand the scope of service automation, screen recognition and action plan are automatically generated, and information on IT service target equipment and web services are managed. In the overall system configuration illustrated in FIG. 1B, the ITOMS 300 is a key component that functions as an intermediary between the local VLM 200 and the RPACA 400, transfers a request received from the task request area 100 to the VLM 200, and converts the generated plan into a form that may be executed by the RPACA 400.

A process of receiving the task request (S1000) of the input unit 110 in natural language, generating a step-by-step detailed task, and confirming the task using the input unit 110 is closely linked to the processing process of the VLM 200 described in FIGS. 2A and 2B. As illustrated in FIGS. 3A and 3B, the ITOMS 300 analyzes and optimizes the task plan and script received from the VLM 200 (S3000) and transfers the task plan and script to the RPACA 400, thereby ensuring efficient task execution. Recently, automated GPT technologies such as Microsoft Jarvis and Agent GPT have been developed. However, all these technologies merely generate decision-making (thoughts). However, the present disclosure goes further and develops multi-step complex tasks (Actions) and script generation technologies to implement actual task automation.

The ITOMS 300 of the present disclosure implements an integrated RPA system that automatically generates and operates scripts for the first time in the world through linkage with the VLM 200. This, combined with a real-time object recognition function of the RPACA 400 illustrated in FIG. 4, provides an innovative system that may automate even a single complex task quickly and easily, unlike existing RPAs that repeatedly perform pre-written scripts. Through a verification process in the test environment 500 and the actual environment 600 illustrated in FIG. 5, the ITOMS 300 ensures accuracy and stability of the generated script, and continuously improves performance by linking with the training data of the VLM 200 illustrated in FIGS. 6 and 7. In addition, by organic linkage with a development process of the real-time object recognition RPA 400 illustrated in FIG. 8, a problem of complex task automation that cannot be performed by existing RPAs is effectively solved through linkage with the ITOMS 300 and the RPA 400. This integrated approach significantly expands the scope of task automation in a company, and provides an environment in which even non-experts may easily utilize the automation system through a user-friendly interface.

The automation system and method using the vision-language agent VLAgent of the present disclosure provide the following effects.

Through a flexible installation environment (Cloud or Local Install), the existing LLM had a problem in which internal data of the company could be leaked to the LLM server. The VLM system of the present disclosure may be installed in a cloud environment or an internal closed network of the company according to the requirements and security policies of the company, providing an optimal operating environment suitable for a situation of the company. In particular, through installation of an internal closed network of the company, external leakage of important data may be blocked at the source, and benefits of AI-based automation may be maximized while complying with security policies.

Through an advanced task processing function (Chain of Action Thought), the present disclosure provides an enterprise-level function that may automatically create and execute complex multi-step tasks through a chain of continuous thought (COAT) actions and beyond a simple image question/answer VQA function. By automatically planning and executing detailed steps for performing actual tasks rather than simple responses through the COAT method, practical task automation is realized. By decomposing a complex task process into logical steps and sequentially executing the steps, high-accuracy task processing becomes possible.

Through a reliable RPA agent, the AI-based RPA system detects and supplements potential errors or inaccurate judgments (hallucinations) of the VLM, ensuring stable and reliable task execution. AI-based RPA verifies and corrects determination of the VLM in real time, ensuring error-free automation execution. Stability in an actual environment is ensured through prior verification in the test environment.

A user-friendly environment is provided in which task managers may directly create and utilize daily task execution processes as training data without programming knowledge through a No-Expert function. Through a function that automatically records an actual task execution process and converts the process into training data, the expertise of field managers may be directly reflected in the system. Continuous performance improvement is possible using a data-based self-learning function.

Through an integrated automation system (Total System), the present disclosure fully supports the entire service automation life cycle from automatic execution of a task of a general user to service monitoring, AI-based fault prediction, and automatic fault recovery. System downtime is minimized through automatic detection and recovery functions in the event of a fault. System stability is maximized by a prediction-based proactive fault response.

The present disclosure provides a flexible architecture that allows easy addition and expansion of new automation services through data learning alone without a separate system integration (SI) task through service-oriented design. Rapid construction and application are possible through data-based service expansion. Easy integration with existing systems allows gradual introduction of automation.

The present disclosure provides a user-friendly environment in which task managers may directly create and utilize routine task execution processes as training data without programming knowledge. The ability to automatically record actual task execution processes and convert the processes into training data allows the expertise of field managers to be directly reflected in the system. Continuous performance improvement is possible using the data-based self-learning function.

The present disclosure fully supports the entire service automation life cycle from automatic execution of tasks of general users to service monitoring, AI-based fault prediction, and automatic fault recovery. The present disclosure minimizes system downtime through automatic detection and recovery functions in the event of a fault. The present disclosure maximizes system stability by a prediction-based proactive fault response.

The present disclosure provides a flexible architecture that allows easy addition and expansion of new automation services through data learning alone without a separate system integration (SI) task. Data-based service expansion enables rapid construction and application. Easy integration with existing systems allows gradual introduction of automation.

The present disclosure provides a stable business model that generates continuous license revenue when adding automation services and expanding target equipment and web services, and has a structure that may grow together with the growth of customers. The present disclosure implements a sustainable business model by increasing license revenue according to expansion of service scope. It is possible to expand step-by-step according to digital transformation levels of customers.

These effects are achieved by the organic combination and operation of the components of the present disclosure, and in particular, the effects are implemented through the synergy of the intelligent determination of the local VLM, accurate execution of the RPACA, and continuous support of the AI models.

1. A method of training and generating a local vision-language model (VLM), the method comprising:
collecting seed data and configuring a standard dataset;
augmenting data in a self-instruct manner;
expanding a training dataset by generating similar data based on the augmented data;
combining a screen recognizer (vision transformer (VIT)) and a large language model (LLM);
fine-tuning the local VLM using the expanded training dataset; and
verifying model performance based on a (Chain of Vision) CoV.

2. The method according to claim 1, wherein the training dataset includes input data of image-text pair data and output data of action data for an action type.

3. The method according to claim 1, wherein:
the method comprises a data analysis and augmentation step and a fine-tuning step,
in the data analysis and augmentation step, a standard dataset is formed from seed data, and 10 times more similar data is generated through self-instruct data augmentation, and
in the fine-tuning step, the local VLM is fine-tuned by combining the VIT and the LLM and verified based on the CoV.

4. An automation method using a vision-language agent, the method performing an automated task by utilizing a natural language-based task request and screen data, the method comprising:
receiving a natural language-based task request from a user;
capturing and analyzing a current display screen;
automatically generating a task execution plan and script including two steps of task planning and action planning by inputting the task request and a screen analysis result to the local VLM trained according to claim 1;
processing the generated script in an automation main system (ITOMS);
verifying safety of a task plan generated in a test environment and confirming executability thereof;
performing one or more of a click action and a text input action based on coordinates defined in a script in an actual environment through an RPA component (RPACA); and
providing a task execution result to a user.

5. The automation method according to claim 4, wherein:
the task planning step decomposes a user request into a plurality of detailed tasks, and
the action planning step converts each detailed task into one or more actual executable specific actions among a click action that designates a specific location on a screen as pixel-unit coordinates and a text input action that automatically inputs required text.

6. The automation method according to claim 4, further comprising supporting a task of the RPA component in artificial intelligence (AI) models,
wherein the supporting comprises providing object detection and text recognition and performing load prediction and fault determination.

7. The automation method according to claim 4, further comprising verifying safety of the task plan generated in the test environment and confirming executability,
wherein the performing one or more of a click action and a text input action based on coordinates comprises performing one or more of the click action and the text input action based on coordinates defined in the script in the actual environment.

8. An automation system using a vision-language agent (VLAgent) in which a screen recognition technology and a language model are combined, the automation system comprising:
an input unit configured to receive a natural language-based task request from a user;
the local VLM trained according to claim 1, the local VLM comprising a VIT configured to capture and analyze a display screen to extract visual information, an LLM configured to understand user request content and analyze context, and a task plan and script generator configured to generate an automation execution plan and script based on information processed by the VIT and the LLM;
an ITOMS configured to process a script generated in the local VLM and manage execution;
a real-time object recognition RPA component configured to perform one or more of actions of coordinate-based click and text input on a screen according to an instruction of the ITOMS; and
an AI model comprising an object detection and text recognizer configured to identify a UI element and text on the screen.

9. The automation system according to claim 8, wherein the VIT and the LLM of the local VLM exchange information with each other and collaborate to perform integrated processing of visual information and text information.

10. The automation system according to claim 8, wherein:
the automation execution plan generated by the task plan and script generator includes two steps of task planning and action planning,
the task planning decomposes a user request into a plurality of detailed tasks, and
the action planning converts each detailed task into one or more actual executable specific actions among a click action that designates a specific location on the screen as pixel-unit coordinates and a text input action that automatically inputs required text.

11. The automation system according to claim 8, further comprising an automation verification unit configured to perform verification in a test environment before execution of a generated task execution script, optimize the script based on a verification result, and then apply the script to an actual environment.

12. The automation system according to claim 8, wherein the real-time object recognition RPA component verifies a plan in a test environment, then executes the plan in a real environment, and performs a task by receiving continuous support from the AI model.

13. The automation system according to claim 8, wherein:
the AI model further comprises a load prediction and fault discriminator, and
the system further comprises a server/web fault detector configured to automatically detect and analyze server and web faults and notify the ITOMS.

14. An automation method using a vision-language agent, the method performing an automated task by utilizing a natural language-based task request and screen data, the method comprising:
receiving a natural language-based task request from a user;
capturing and analyzing a current display screen;
automatically generating a task execution plan and script including two steps of task planning and action planning by inputting the task request and a screen analysis result to the local VLM trained according to claim 1;
processing the generated script in an ITOMS;
performing one or more of a click action and a text input action based on coordinates defined in a script through an RPA component; and
providing a task execution result to a user.

15. An automatic fault detection and recovery system based on a vision-language agent for fault detection and automatic recovery, the system comprising:
a fault detector configured to detect a server or web fault and generate a fault notification;
the local VLM trained according to claim 1, the local VLM comprising a VIT configured to capture and analyze a display screen to extract visual information, an LLM configured to understand user request content and analyze context, and a task plan and script generator configured to generate an automation execution plan and script based on information processed by the VIT and the LLM;
an ITOMS configured to receive and manage a recovery plan generated by the local VLM;
a real-time object recognition RPA component configured to verify the recovery plan in a test environment and then execute a recovery task in an actual environment; and
an AI model configured to support object detection, text recognition, load prediction, and fault determination.

16. The automatic fault detection and recovery system according to claim 15, wherein the VIT and the LLM of the local VLM exchange information with each other and collaborate to perform integrated processing of visual information and text information.

17. The automatic fault detection and recovery system according to claim 15, wherein:
an entire process from fault detection to recovery result reporting is automated in the system,
a screen capture and analysis request is processed after receiving a fault notification,
a recovery plan is generated and delivered,
execution is performed in an actual environment after verification in a test environment,
a task is performed by receiving support for object detection and text recognition and support for load prediction and fault determination, and
a final result is reported to a user.

18. The automatic fault detection and recovery system according to claim 15, wherein:
the AI model comprises a load prediction and fault discriminator, and
the system further comprises a server/web fault detector configured to automatically detect and analyze server and web faults and notify the ITOMS.

19. A non-transitory computer-readable recording medium storing a computer program for implementing a VLAgent system configured to process a natural language-based task request and perform an automated task, the computer program comprising instructions to execute steps of:
receiving a natural language-based task request from a user;
capturing and analyzing a current display screen;
automatically generating a task execution plan and script including two steps of task planning and action planning by inputting the task request and a screen analysis result to the local VLM trained according to claim 1;
processing the generated script;
performing one or more of a click action and a text input action based on coordinates defined in a script; and
providing a task execution result to a user.
